(19) United States
(12) Patent Application Publication
(10) Pub. No.: US 2004/0227694 A1
(43) Pub. Date: Nov. 18, 2004

(54) System and method for a three-dimensional color image display utilizing laser induced fluorescence of nanopartcles and organometallic molecules in a transparent medium

(76) Inventors: Xiao-Dong Sun, Fremont, CA (US); Jian-Qiang Liu, Campbell, CA (US)

Correspondence Address: CHARLES QIAN, 1018 CRANBERRY DR., CUPERTINO, CA, 95014, US

(21) Appl. No.: 10/843,083

(22) Filed: May 10, 2004

Related U.S. Application Data
(60) Provisional application No. 60/470,530, filed on May 14, 2003.

(51) Int. Cl. G09G 5/00

(52) U.S. Cl. 345/6

(57) ABSTRACT

A system and a method of a three-dimensional color image display utilizing laser induced fluorescence (LIF) of nano-particles and molecules in a transparent medium are disclosed. In one preferred embodiment, a three-dimensional display volume contains three types (for red, green and blue color) of LIF nano-particles and/or molecules dispersed in a random, uniform fashion in a transparent, fluid like medium. In another preferred embodiment, a color image display system consists of at least two light sources each equipped with two-dimensional scanning hardware and a LIF display volume, a protective coating and at least two light sensors. The protective wavelength filtering coating blocks intense excitation light sources from harming image viewers while passing the LIF display light. The light sensors provide calibration and timing reference signals to maintain stable performance. A host of preferred fluorescence materials are also disclosed. These materials fall into three categories: inorganic nano-meter sized phosphors; semiconductor based nano particles; fluorescent polymers, dye molecules and organometallic molecules. Additionally, a preferred fast laser scanning system is disclosed. The preferred scanning system consists of dual-axes acousto-optic light deflector, signal processing and control circuits equipped with a close-loop image feedback to maintain position accuracy and pointing stability of the laser beam.

This application claims priority to the provisional application entitled “Advanced volumetric display systems and materials used therein”, Ser. No. 60/470,530, filed by the same subject inventors and assignee as the subject invention on May 14, 2003.

### BACKGROUND OF THE INVENTION

1. Field of the Invention

The present invention relates generally to displays and more particularly to a system and a method for three-dimensional cross-beam displays utilizing advanced transparent laser induced fluorescence medium.

2. Background Art

Image display and associated technologies are a fundamental necessity of today's society. Application areas include communication, entertainment, military, medical and health. Traditionally, a display system consists of a source beam, beam masks or deflectors, and a two-dimension projection screen. Unlike sound based technologies where close to real life experience can be reproduced in a home theater through the use of a group of speakers, image display remains largely two-dimensional. There is need for compact, user friendly, “real” 3-dimensional display systems, based on a static volumetric display method called cross-beam display. Development and commercialization of affordable and high quality direct view 3-D displays will significantly impact our society and lead to advances in applications in medical imaging displays (e.g. CT, MRI), commercial information displays and potential 3-D video displays.

A crossed laser beams based, compact 3-D display has been demonstrated at Stanford University (see, for example, “A three-color, Solid-state, Three-dimensional Display” published in Science, vol. 273, pp 1185-89, 1996, referred as “Science”) in 1996. As demonstrated in FIG. 1a, this 3-D system uses principle of laser up-conversion where stepwise exciting color centers with two infrared photons. Color centers (rare earth ions in transparent host) can then emit visible light to form a visible image. In FIG. 1b, the physical layout of the display system is illustrated; two infrared laser beams are steered to cross at a specified position at a particular time through two scanners. A 3-D image is formed by a sequence of the displayed positions in the 3-D (voxels). Two prior art approaches for 3-D displaying volumes are known and illustrated in FIGS. 2a and 2b. In FIG. 2a, a prior art approach developed by Downing and co-workers is depicted. By stacking of three displaying layers (one for each color), a 3-D display volume is formed. Each layer is formed with crystals doped with cations of a particular rear earth element. The layered structure is necessary since excited state quenching prevents a single displaying solid to be formed with three different kinds of ions co-doped. In FIG. 2b, a structure proposed by Bass and co-inventors is illustrated. In this structure, voxels are placed in a three dimensional matrix following a regular pattern. These voxels are formed by enclosing dye molecules in plastic micro volumes, with sizes from 0.5 μm to 50 μm.

The crossbeam volumetric display concept was first proposed and demonstrated by Lewis et al. in 1971 (see for example, J. Lewis, C. Verber, R. McGhee, IEEE Trans Electron Devices, vol 18, pp724, 1971). They have generated a 3-D voxel using a Xe lamp as light sources and erbium doped calcium fluoride crystal as display medium. This approach remains a pioneer research due largely to the difficulty to manipulate the incoherent light from the Xe lamp and the lack of adequate display medium that can be efficiently excited by cross-beams.

Two groups carried out the most relevant prior art 3-D cross-beam display works. Of particular interests are the work by E. Downing et. al, as described in Science. The work described in the Science article formed basis for several US patents granted. See for example, U.S. Pat. Nos. 5,684,621; 5,764,403; 5,914,807; 5,943,160; and U.S. Pat. No. 5,956,172 all to Downing. M. Bass and co-workers, at the University at Central Florida, carried out other related research works. Several related US patents were issued. See for example, U.S. Pat. Nos. 6,327,074; 6,501,590; and 6,654,161; to Bass and co-inventors. These patents and article are thereby included herein by ways of reference.

There are several areas that can be improved on these prior art three-dimensional displays. For instance, in the case of rare earth doped metal halide glasses (e.g. ZBLAN) used by Downing (Column 9 line 45 of “621”), it is very difficult and expensive to obtain a practical volume of special doped glass. Indeed the display medium used is only “sugar cube” sized (˜1 cm³) crystal (FIG. 7 of Science). The 3-D crossbeam display medium disclosed by Bass etc. is also problematic: Pure organic dyes (e.g. Rhodamine used in “074”) are very poor 2-photon upconversion materials, with extremely small 2-photon absorption cress sections. Very intensive Q-switched pulsed solid state lasers (e.g. YAG:Ce) have to be used (column 6 line 37 of “074”). The use of such bulky and high power laboratory lasers are impractical and present safety hazards and cost issues. In the phosphor particles disclosed by Bass and co-inventors, sizes of 0.5 to 50 microns were preferred. Unfortunately, particles in such range will significantly scatter visible fluorescence light. Hence the whole 3-D display volume becomes optically opaque and prevent volumetric image inside to be viewed. A more challenging condition is that the refractive index of phosphor (˜2.0) must match that of the transparent medium (column 5 line 60 of “074”). Bass and co-inventors failed to identify specific examples of an up-conversion crystal particle with matching index to a transparent medium.

It is desirable to have bright and less expensive 3-D display volumes with color centers dispersed in a random, uniform fashion, in a transparent medium. For realistic displaying systems, in order to display 3D image in an eye safe environment, a radiation shield must be incorporated. Additionally, to ensure the uniformity of the crossing points, i.e., the overlapping of two small light beams, proper feedback loops must be included in the 3-D displaying systems. Inexpensive manufacturing processes are also the key to a practical display technology. There is a need therefore to have improvements to these prior arts such that inexpensive and practical 3-D displays can be made.

### SUMMARY OF THE INVENTION

The present invention discloses an improved system and method, materials and designs of a 3-D image display that utilizes laser induced fluorescence (LIF) process. The disclosed display consists of at least two laser sources, a display volume containing uniformly dispersed (dissolved) fluorescent nano-particles and/or organometallic molecules, light beam steering mechanisms, and feedback loops. The display volume containing the emission centers is a stable and uniform medium without multiple layers or micron-sized particles. Emission centers of multiple colors can be dispersed or dissolved in the same transparent medium for the cross-beam display. Once illuminated, the fluorescent volume converts the infrared and/or near infrared laser lights into red, green or blue emissions, at the laser crossing point. Rastering or scanning of the laser crossing point in the special medium according to a predefined or a programmed data generates a real 3-D image in the fluorescent volume.

In one preferred embodiment, a three-dimensional display volume contains three types (for red, green and blue color) of LIF nano-particles and/or molecules dispersed (dissolved) in a random, uniform fashion in a transparent, fluid like medium. The transparent medium may be a liquid, a solid or a gel-like material. The volume is enclosed with a protective shell, that is also transparent to the viewer.

In another preferred embodiment, a color image display system consists of at least two light sources each equipped with two-dimensional scanning hardware and a LIF display volume, a protective coating and at least two light sensors. The protective wavelength filtering coating blocks intense excitation light sources from harming image viewers while passing the LIF display light. The light sensors provide calibration and timing reference signals to maintain stable performance. To display multiple colors in the volume, fluorescent molecules or nano-particles of different emitting wavelengths are dispersed (dissolved) in the displaying region; multiple lasers of different wavelengths may be combined and illuminated in the volume. Composite displaying colors are obtained through the mixing of three basic emitting colors. Molecules or nano-particles with different fluorescent colors are co-dispersed in a random, uniform fashion in single volume.

A host of preferred fluorescence materials are also disclosed. These materials fall into three categories: inorganic nano-meter sized up-conversion phosphors; semiconductor based nano particles (e.g., quantum dots); and organometallic fluorescent molecules. Additionally, a preferred fast laser scanning system is disclosed. The preferred scanning system consists of dual-axes acousto-optic light deflector, signal processing and control circuits equipped with a close-loop image feedback to maintain position accuracy and pointing stability of the laser beam.

A preferred method of image display is disclosed. In this method, two light beams, each is coupled with a two-dimensional laser scanner (e.g., galvanometer, acousto-optic light deflector (AOLD), and electro-optic light deflector (EOLD)) are crossed at a particular point. Electrical signals are applied to steer the crossing point to illuminate a particular spot in the volume at a given time. Additionally, signal processing and control circuits are used and equipped with a close-loop image feedback to maintain position accuracy and pointing stability of the laser beam.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1a illustrates a prior art up-conversion energy level diagram and mechanism;

FIG. 1b depicts a prior art crossed beam based 3-D display setup;

FIG. 2a shows the structure of a prior art 3-D display volume;

FIG. 2b displays the structure of another prior art 3-D display volume;

FIG. 3 displays an improved 3-D display volume;

FIG. 4 illustrates an improved 3-D display system;

FIG. 5A through 5C show chemical structure formula of 3 preferred display organometallic molecules.

FIG. 6 illustrates an improved LIF image display systems.

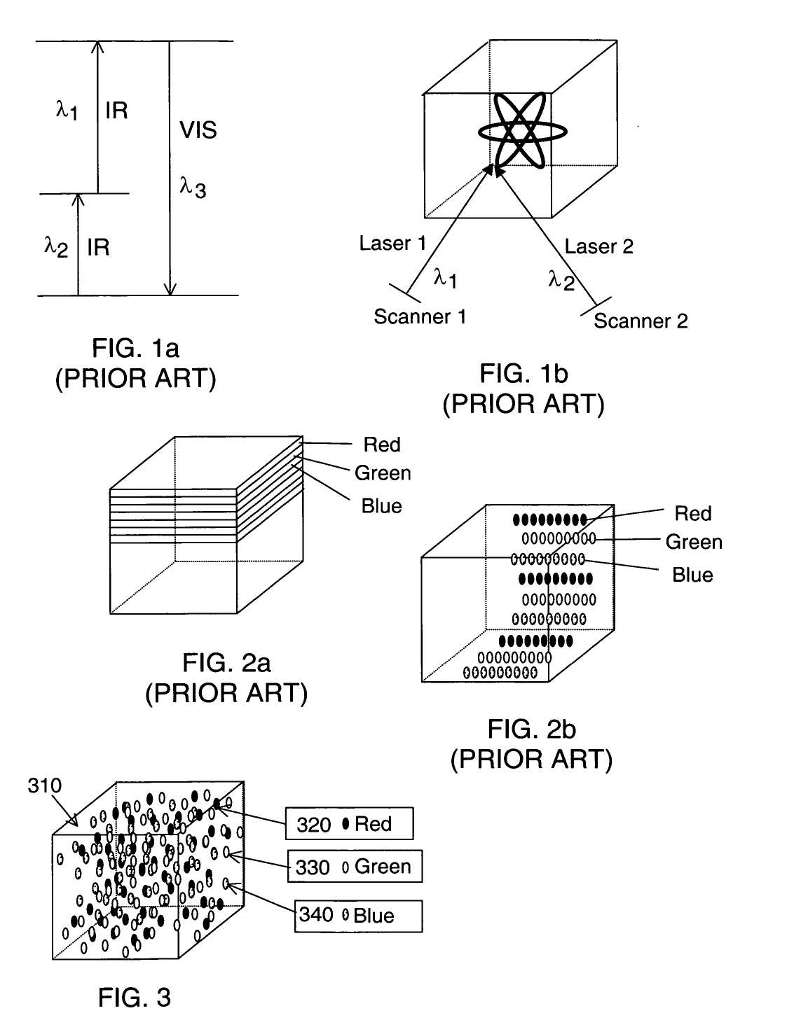

### DETAILED DESCRIPTION OF THE INVENTION

The present invention discloses an improved system and method, materials and designs of a thee-dimensional image display that utilizes laser induced fluorescence (LIF) process. The improved display system disclosed herein consists of at least two laser sources, a display region containing fluorescent nano-particles and/or molecules, photo-acoustic light beam steering mechanisms, and feedback mechanisms. The laser sources are steered in a crossed beam configurations and excite a small volume at the crossing point through a two-photon laser excitation mechanism. Once illuminated, the fluorescent volume converts the infrared or near infrared laser lights into red, green or blue emissions. Rastering or scanning of the laser crossing points according to a predefined or a programmed data generates a 3-D image in the fluorescent volume.

The first preferred embodiment of the present invention is illustrated in FIG. 3. A three-dimensional display volume contains three types (for red 320, green 330 and blue 340 color) of LIF nano-particles and/or molecules dispersed in a random, uniform fashion in a transparent, fluid like medium. The transparent medium may be a liquid, a solid or a gel-like material. The volume is enclosed with a protective shell that is also transparent to the viewer. It is important to point out that the transparent medium absorbs very little visible light however it does absorb infrared or near infrared radiation and it is therefore not transparent to those wavelengths.

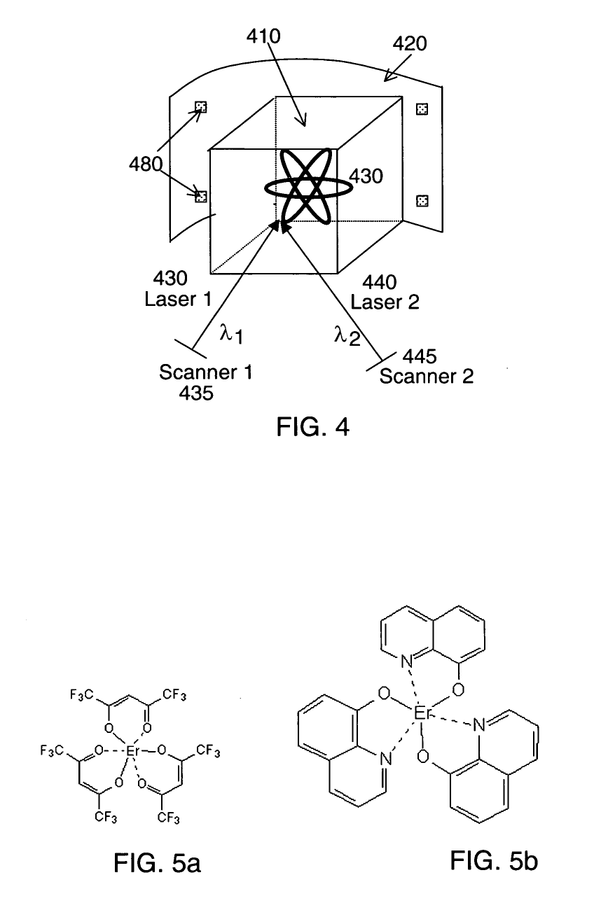

The second preferred embodiment of the present invention is depicted in FIG. 4. Two lasers (430, 440) deliver two intense, collimated beams of infrared or near infrared radiation in to a 3-D displaying volume 410. The radiation beams are steered through two scanners (435, 445) and at the beam crossing point, two-photon excitation will lead laser induced fluorescence pattern 430. In the preferred system, each radiation beam is coupled with a two-dimensional laser scanner (e.g., galvanometer, acousto-optic light deflector (AOLD), and electro-optic light deflector (EOLD)). Electrical signals are applied to steer the radiation beam to illuminate a particular crossing point of the displaying volume at a given time. The preferred LIF volume typically has at least one type of LIF molecules or nano-particles dispersed in a transparent medium. The preferred 3-D displaying system further includes a protective layer 420, placed substantially close to the displaying volume. The protection layer passes visible fluorescence while blocks intense IR and near IR radiations. In addition, there exist at least two light position sensors 480 attached to certain locations near the display. These sensors aid the displaying system to best coordinate the overlapping and scanning of the laser beams by providing the calibration and timing reference signals. To display multiple colors in the volume, fluorescent molecules or nano-particles of different emitting wavelengths are dispersed in the displaying region; multiple lasers of different wavelengths may beicombined and illuminated in the volume. Composite displaying colors are obtained through the mixing of three basic emitting colors. Molecules or nanoparticles with different fluorescent colors are co-dispersed (dissolved) in a random, uniform fashion in a single medium volume.

One preferred 3-D display has a spherical shape and measures about 7 inches. The outer spherical shell is made with visible transmitting, IR absorbing materials with two IR transmitting windows to pass the exciting laser beams. Alternatively, an IR absorbing visible transmitting film is deposited on the outer spherical shell. The 3-D display volume is a region with diameter measuring about 4 inches. The diameter of each voxel is about 0.7 mm. The resolution of the 3-D display is about 1 mm and the image preferably has a refresh rate of 15 to 60 Hz.

A host of preferred fluorescence materials are also disclosed. These materials fall into four categories: inorganic nano-meter sized phosphors; organic polymers containing unsaturated C—C bonds; semiconductor based nano particles; and organometallic molecules.

The fluorescent up-conversion phosphors are a class of preferred materials for 3-D volumetric displays. Instead of using glass as host for the phosphors, nano-particulate up-conversion phosphors (size 0.5 nm to 500 nm) of interest are dispersed (dissolved) in an optically transparent or translucent host fluid like medium. Phosphors comprising of metal fluorides, metal oxides, metal chalcoginides (e.g. sulfides), or their hybrids, such as metal oxo-halides, metal oxo-chalcoginides, doped with rare earth elements (e.g. Yb³⁺, Er³⁺, Pr³⁺, Ho³⁺, Tm³⁺) may be used. Potential host material includes, but not limited to: NaYF₄, YF₃, BaYF₅, LaF₃, La₂MoO₈, LaNbO₄, LnO₂S, Ln₂O₃, Ln(Mm)Oₓ; where Ln is the rare earth elements, such as Y, La, Gd, M is the IIIA and IVA metals and semiconductors including B, Al, Ga, Si Ge and their mixture, m is an integer from 0 to 10. Fine-particulates suspensions of up-conversion phosphors may also be preferred as an effective approach to 3-D fluorescent display media. The nano-particle suspension can be stable over time with excellent optical transparency when the concentration of suspended nano-particle is below 1 g/ml.

In addition, there are many polymers containing unsaturated C—C bonds, which can be fluorescent materials and be a preferred 3-D display material. For example, poly[2-methoxy-5-(2′-ethyl-hexyloxy)-1,4-phenylene vinylene (MEH-PPV), PPV, etc have been used in optoelectronic devices, such as polymer light emitting diodes (PLED). These polymers may absorb at least 2 IR photons with emission of visible light, and can be used in the 3-D volumetric displays.

The third class of preferred color center materials in the 3D volumetric displays is recently developed semiconductor particles or nano-particles (e.g., quantum dots). These semiconductor based color centers have novel luminescent properties. Up-conversion luminescence was observed in InP, CdSe, CdTe based particles. The terms “semiconductor nano-particles,” refers to an inorganic crystallite particle formed with semiconductor elements measuring between 1 nm to 1000 nm in diameter, more preferably between 2 nm to 50 nm. The nano-particle can be either an homogeneous nano-crystal, or comprising of multiple shells. For example, it includes a “core” of one or more first semiconductor materials, and may be surrounded by a “shell” of a second semiconductor material. A semiconductor nano-particle core surrounded by a semiconductor shell is referred to as a “core/shell” semiconductor nano-crystal. The surrounding “shell” material preferably have an energy band gap that is larger than that of the core and may be chosen to have an atomic spacing close to that of the “core” substrate. The core and/or the shell can be a semiconductor material including, but not limited to, those of the group II-VI (ZnS, ZnSe, ZnTe, CdS, CdSe, CdTe, HgS, HgSe, HgTe, MgS, MgSe, MgTe, CaS, CaSe, CaTe, SrS, SrSe, SrTe, BaS, BaSe, BaTe, and the like) and III-V (GaN, GaP, GaAs, GaSb, InN, InP, InAs, InSb, and the like) and IV (Ge, Si, and the like) materials, and an alloy or a mixture thereof.

Finally, fluorescent organometallic molecules containing rare earth or transitional element centers form another class of the preferred color center materials. These molecules include complexes containing rare earth elements Eu, Tb, Pr, Er, Tm, Ho, Ce with organic chelating groups (e.g. cage or metal cryptate compounds). The metal elements in the organic complex also include transitional elements such as Zn, Mn, Cr, Ir, etc and main group elements such as B. Such organometallic molecules can readily dissolve in liquid or transparent solid host medium and form a transparent fluorescent volume. Selected examples of such fluorescent organomettalic molecules include: 1. Erbium Hexafluoropentanedionate; 2. Tris(8-hydroxyquinoline) erbium; 3. Tris(1-phenyl-3-methyl-4-(2,2-dimethylpropan-1-oyl)-pyrazolin-5-one) terbium (III). The chemical formulas of these complexes are given in FIGS. 5a through 5c, respectively. Other metal element such as Pr, Tm, Ho, etc can find similar organic chelating complex and such fluorescent organometallic molecules can be dissolved in organic solvents to form a transparent solution medium for 3D display, without any solid particles in the liquid. Alternatively, they can also be dissolved in transparent solid hosts such as polymers and glasses to form a solid medium for 3D display. Such compounds will be in the form of molecules in the liquid or solid medium, hence a highly transparent display medium can be prepared without any issue of light scattering. Any size or shape of volume or container can be readily filled with such organometallic molecules dissolved medium as the volume of the 3-D crossbeam display.

The preferred color center materials together with transparent or translucent host material form the display volume can take one of the following forms: liquid solution; solid polymer; solid glass; liquid suspension; liquid colloid; aerosol; and gel.

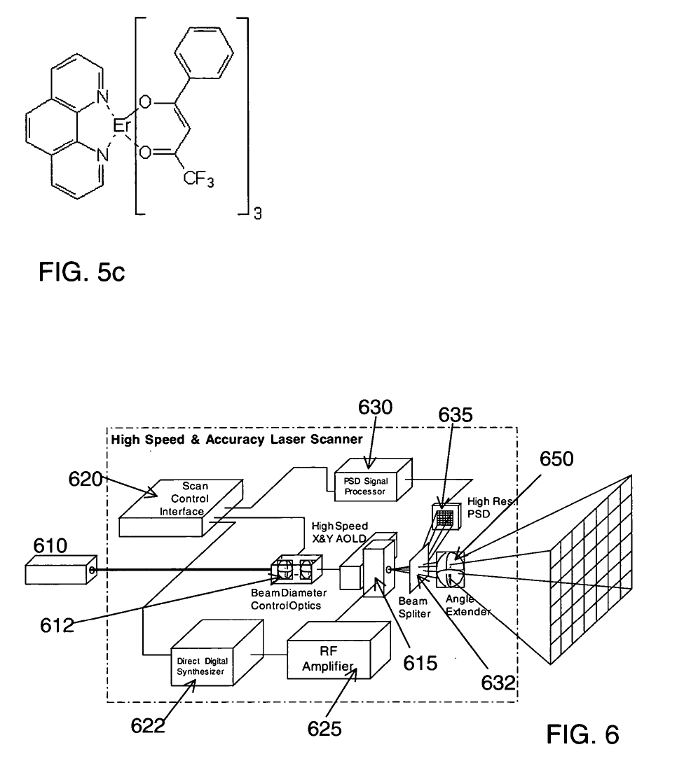

Referring now to FIG. 6, a detailed diagram illustrates an additional preferred embodiment of a two-dimensional laser steering subsystem. The laser source 610 preferably passes through a set of beam-diameter control optics 612 and a 2-D acousto-optical scanner 615. A scan control interface unit 620 coordinates the functions of a Direct Digital Synthesizer 622, an RF amplifier 625 and Beam-Diameter Control Optics 612. The processes image beam is projected on to a LIF volume through an angle extender 650. In order to deliver consistent and stable image to the LIF volume, a beam splitter deflects the image into a position sensitive detector 635 and processed through 630, feedback to 620. The close-loop image feedback formed by 632, 635, 630 and 620 is incorporated to maintain position accuracy and pointing stability of the laser beam.

It will be apparent to those with ordinary skill of the art that many variations and modifications can be made to the system, method, material and apparatus of LIF based 3-D display disclosed herein without departing form the spirit and scope of the present invention. It is therefore intended that the present invention cover the modifications and variations of this invention provided that they come within the scope of the appended claims and their equivalents,

We claim:

1. A three-dimensional color image display setup based on laser induced fluorescence comprising:
at least two laser systems operating in a wavelength range of >700 nm;
at least one optical beam steering unit for one of the said laser beam to specified positions with specified light intensities;
a displaying volume comprising transparent fluid like medium containing at least one type of electro-magnetic radiation activated visible light emitting particles;
a coating or film surrounding the said transparent medium of the said displaying volume separating the said visible light from the said activation radiation;
an enclosing shell of transparent materials protecting the said fluorescent layer of the said displaying volume.

2. The three-dimensional color image display setup recited in claim 1 wherein the said enclosing shell being glass shell.

3. The three-dimensional color image display setup recited in claim 1 wherein the said enclosing shell being made with polymer material.

4. The three-dimensional color image display setup recited in claim 1 wherein the said enclosing shell being a thin film or being absent.

5. The three-dimensional color image display setup recited in claim 1 wherein the said transparent medium of the said fluorescent volume being a transparent liquid.

6. The three-dimensional color image display setup recited in claim 1 wherein the said transparent medium of the said fluorescent volume being a transparent solid.

7. The three-dimensional color image display setup recited in claim 1 wherein the said electro-magnetic radiation activated visible light emitting particles absorbing electromagnetic radiation in the wavelength range of >700 nm while emitting visible light in the wavelength range <700 nm and >400 nm.

8. The three-dimensional color image display setup recited in claim 1 wherein the said electro-magnetic radiation activated visible light emitting particles containing semiconductor elements with dimensions between 1 nm to 1 μm.

9. The three-dimensional color image display setup recited in claim 1 wherein the said electro-magnetic radiation activated visible light emitting particles containing laser dye or organic molecules with dimensions between 0.5 nm to 100 nm.

10. The three-dimensional color image display setup recited in claim 1 wherein the said electro-magnetic radiation activated visible light emitting particles containing inorganic phosphors with dimensions between 1 nm to 500 nm.

11. The three-dimensional color image display setup recited in claim 1 wherein the said electro-magnetic radiation activated visible light emitting particles containing at least one type of metallic element (atoms or ions) and organic ligands with particle dimensions between 0.5 nm to 500 nm.

12. A laser induced fluorescence volume for three-dimensional color image display comprising:
at least one fluorescent volume of transparent medium containing at least one type of electromagnetic radiation activated visible light emitting particles;
a coating or film surrounding the said volume of transparent medium separating the said visible light from the said activation radiation;
an enclosing shell of transparent materials protecting the said fluorescent volume.

13. The laser induced fluorescence volume recited in claim 12 wherein the said enclosing shell being glass shell.

14. The laser-induced fluorescence volume recited in claim 12 wherein the said enclosing shell being made with polymer material.

15. The laser-induced fluorescence volume recited in claim 12 wherein the said enclosing shell being a thin film or absent.

16. The laser induced fluorescence volume recited in claim 12 wherein the said transparent medium of the said fluorescent volume being a transparent liquid.

17. The laser induced fluorescence volume recited in claim 12 wherein the said transparent medium of the said fluorescent volume being a transparent solid.

18. The laser induced fluorescence volume recited in claim 12 wherein the said electro-magnetic radiation activated visible light emitting particles absorbing electromagnetic radiation in the wavelength range >700 nm while emitting visible light in the wavelength range <700 nm and >400 nm.

19. The laser induced fluorescence volume recited in claim 12 wherein the said electro-magnetic radiation activated visible light emitting particles containing semiconductor elements with dimensions between 1 nm to 1 μm.

20. The laser induced fluorescence volume recited in claim 12 wherein the said electro-magnetic radiation activated visible light emitting particles containing laser dye or organic molecules with dimensions between 0.5 nm to 100 nm.

21. The laser induced fluorescence volume recited in claim 12 wherein the said electro-magnetic radiation activated visible light emitting particles contains inorganic phosphors with dimensions between 1 nm to 500 nm.

22. The laser induced fluorescence volume recited in claim 12 wherein the said electro-magnetic radiation activated visible light emitting particles contains at least one type of metallic element (atoms or ions) and organic ligands with particle dimensions between 1 nm to 500 nm.

23. The laser induced fluorescence volume recited in claim 12 wherein the said transparent medium of the said fluorescent volume having dimensions of 1 cm to 100 cm.
